(19) United States
(12) Patent Application Publication
(10) Pub. No.: US 2024/0195092 A1
(43) Pub. Date: Jun. 13, 2024

(54) CONNECTOR FOR A HIGH VOLTAGE CONNECTION INSIDE AN ELECTRICAL DEVICE

(71) Applicant: BorgWarner lnc., Auburn Hills, MI (US)

(72) Inventors: Stein Liu, Ningbo (CN); Jackey Hu, Ningbo (CN); Charlie Yuan, Ningbo (CN)

(21) Appl. No.: 18/531,306

(22) Filed: Dec. 6, 2023

(30) Foreign Application Priority Data
Dec. 7, 2022 (DE) 10 2022 132 476.1

(51) Int. Cl. H01R 12/58; H05B 3/26

(52) U.S. Cl. CPC H01R 12/585; H05B 3/26

(57) ABSTRACT

Disclosed is a connector for a high voltage connection inside an electrical device, especially for electrically connecting a heating plate to a printed circuit board inside a heating device. The connector has a plastic body and several metallic strips that each have two ends that protrude from the plastic body. The metallic strips form press-fit contacts at least at one of their ends, each metallic strip has a through hole that matches with a corresponding opening of the plastic body, and the plastic body has ring-shaped beads that each surround one of the openings. Also disclosed is a heating device having a heating plate, a printed circuit board, and such a connector electrically connecting the heating plate to the printed circuit board.

### RELATED APPLICATIONS

This application claims priority to DE 10 2022 132 476.1, filed Dec. 7, 2022, the entire disclosure of which is hereby incorporated herein by reference.

### BACKGROUND

This disclosure refers to a connector for high voltage connection inside an electrical device, for example, a connector for electrically connecting a heating plate to a printed circuit board inside a heating device.

Such connectors comprise a plastic body and a plurality of metallic strips protruding from the plastic body. Usually, these strips form at least at one of their ends press-fit contacts. Press-fit contacts are sometimes also called press-in contacts and are typically used to establish an electrical connection to a printed circuit board by means of an interference fit. Significant pressure must be applied in order to press such press-fit contacts into a hole of a printed circuit board or the like.

The connector is produced by overmolding metallic strips with plastic. Care must be taken to ensure that the position of the metallic strips inside a mold is not affected by liquid plastic that is injected into the mold at high pressure during the overmolding process. In addition, the connector must offer excellent electrical isolation suitable for high voltage applications, e.g., several hundred volts.

### SUMMARY

This disclosure provides a connector for high voltage connection inside an electrical device by means of an interference fit with press-fit contacts. This disclosure also provides a high-voltage heating device comprising a connector that electrically connects a heating plate to a printed circuit board.

A connector according to this disclosure comprises a plastic body and a plurality of metal strips that protrude from the plastic body and form press-fit contacts. Each metallic strip has a through hole that matches with a corresponding opening of the plastic body. Thus the connector has a through hole or a blind hole into which a pin or similar tool can be inserted. When the connector is created by overmolding of the metallic strips they can be held inside the mold by pins that engage the through holes of the metallic strips and thereby fix the metallic strips inside the mold such that they are not moved by plastic that is injected into the mold at high pressure.

Holes or openings of the plastic body might impair electrical isolation between the various metallic strips enclosed by the plastic body because creepage or leakage current may flow from one strip through one of the openings of the plastic body along the surface of the plastic body and the adjacent opening to a neighboring strip, especially when even a little moisture is present in air surrounding the connector. Moreover, condensation might cause water to flow directly into the hole and cause shorts.

This problem is overcome or at least mitigated by ring shaped beads surrounding the openings of the plastic body. These beads provide annular walls that increase the creepage distance as any leakage current would have to flow over at least two of such beads. Usually one ring shaped bead surrounding each opening is sufficient, but the creepage distance can be increased even further if every opening is surrounded by several concentric ring shaped beads. A creepage distance of 5.9 mm to 12 mm is advantageous for most applications.

In a refinement of this disclosure, the plastic body may comprise protrusions for insertion into holes of a printed circuit board. Such protrusions may facilitate correct positioning of the connector in relation to a printed circuit board before the press-fit contacts are pressed into the circuit board. Moreover, such protrusions may increase the creepage distance between adjacent ends of neighboring strips that protrude from the plastic body. An advantageous position for such protrusions is therefore between press-fit contacts of neighboring strips.

The metallic strips of the connector may form press-fit contacts at both ends, but it is usually advantageous if press-fit contacts are present only at one end while the other end is adapted for a solder or welding connection. For example, the metallic strips may form solder pads at one of their ends.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an embodiment of a connector for a high voltage connection inside an electrical device;

FIG. 2 shows a side view of the connector shown in FIG. 1;

FIG. 3 shows a frontal view of the connector shown in FIG. 1, wherein the left part of a polymer body of the connector is shown transparently so that the shape of the metal strip is visible;

FIG. 4 shows a printed circuit board and a heating plate that are electrically connected by the connector shown in FIG. 1;

FIG. 5 shows a detail of the heating plate and printed circuit board together with the connector;

FIG. 6. shows the details of FIG. 5 viewed from a different direction; and

FIG. 7 shows a flow heater comprising the heating plate, the printed circuit board and the connector.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

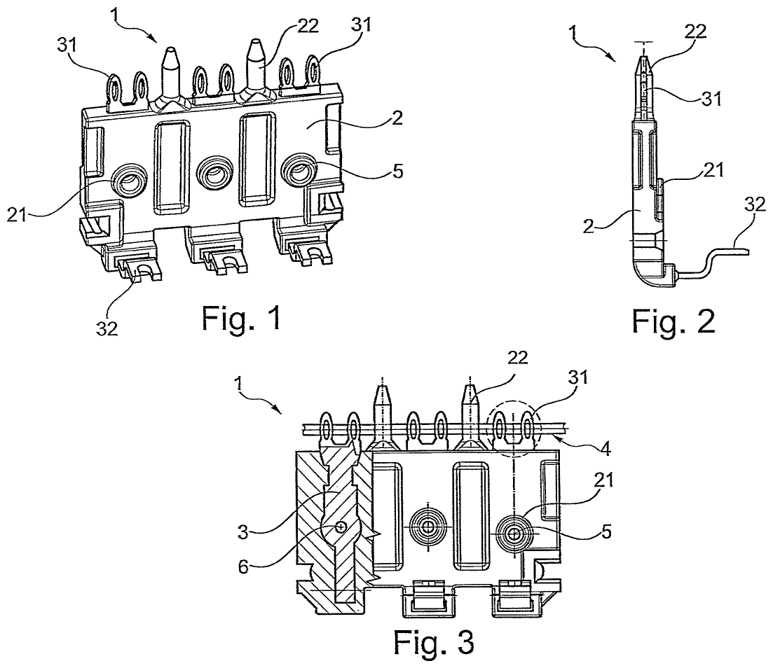

FIGS. 1 to 3 show a connector for creating a high voltage connection inside an electrical device. The connector 1 comprises a plastic body 2 made of an electrically insulating polymer, e.g., polyamide or polyphenylene sulfide, especially PPS with or without fiber enforcement, for example, GF65. Metallic strips 3 are embedded in the plastic body 2 and protrude at both ends from the plastic body 2. At one of their ends each of the metallic strips 3 forms one or more press-fit contacts 31, e.g., two press-fit contacts 31. At their opposite ends the metallic strips form solder pads 32, i.e., are configured for establishing an electrical connection by being soldered to a contact surface. The ends of the metallic strips 3 forming the solder pads 32 are bent at right angles with respect to the opposite ends forming the press-fit contacts 31.

Press-fit contacts 31 are configured to establish an electrical connection by means of an interference fit inside a metallized hole of a printed circuit board or the like. A printed circuit board 4 is shown schematically in FIG. 3. Press-fit contacts need to be deformed when they are pressed into a metallized hole. In order to facilitate this, the press-fit contacts 31 have a bulging middle section and can be provided with a slit or hole in the bulging middle section. The metallic strips 3 may, for example, be made of a copper alloy, e.g., a copper-nickel alloy like C19010. The press-fit contacts 31 may be coated with nickel and/or tin in order to facilitate a good electrical connection with low resistance.

The connector 1 is produced by overmolding the metallic strips 3 with plastic. During this process, the metallic strips are placed in a mold and fixed in their positions by means of pins that are stuck into through holes 6 of the metallic strips 3. After the overmolding process the pins are withdrawn. The plastic body 2 therefore has openings 5, which had been filled by the pins or other tools during the overmolding process. The openings 5 in the plastic body 2 can be through holes or blind holes.

The plastic body 2 comprises ring shaped beads 21 that each surround one of the openings 5 concentrically. The ring shaped beads 21 form annular walls around each opening 5 and thereby increase the creepage distance for any leakage current flowing over the surface of the plastic body 2 into the openings 5 and thus to the metallic strips 3. In the embodiment shown, each opening 5 is surrounded by only one circular bead 21, but each opening 5 may also be surrounded by a plurality of concentric circular beads in order to increase creepage distance even more. A Creepage distance of 5.9 mm or more is advantageous for most applications, especially for voltages of 400 V or more. For most applications creepage distances above 12 mm offer little or no additional advantage.

Another advantage of the ring shaped beads 21 is that in case moisture condenses on the plastic body, the ring shaped beads 21 prevent water from flowing into the openings 5 where it would cause electrical problems.

If the openings 5 are through holes, such circular beads may also be arranged on the backside of the plastic body 2 which is not shown in the figures.

The plastic body 2 also comprises protrusions 22 for insertion into holes of a printed circuit board 4. In the embodiment shown, these protrusions 22 are pins and facilitate correct positioning of the connector 1 before the press-fit contacts 31 are pressed into the printed circuit board 4. The protrusions 22 therefore extend beyond the distal ends of the press-fit contacts 31. As the protrusions 22 are arranged between the press-fit contacts 31 of neighboring metallic strips 3, the protrusions 22 also increase the creepage distance between the press-fit contacts 31 of adjacent metallic strips 3.

Connector 1 shown in FIGS. 1 to 3 comprises three metallic strips 3. The number of metallic strips 3 might be modified according to needs of a given application. In the example shown, one of the metallic strips 3 is used for a ground connection, another metallic strip 3 for a connection to high-voltage potential, and a third metallic strip 3 for a sensor connection.

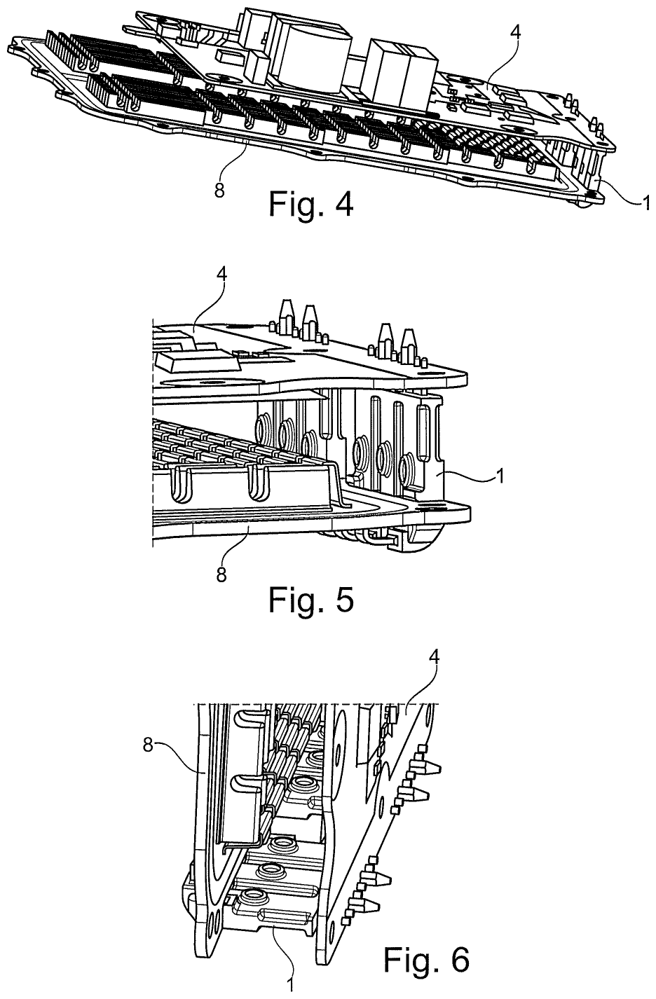

FIGS. 4 to 6 show a printed circuit board 4 and a heating plate 8 that are electrically connected by means of connectors 1 shown in FIGS. 1 to 3. The press-fit contacts 31 of the connectors 1 cause an electrical connection to the printed circuit board. The solder pads 32 of the connectors 1 are soldered to conductive tracks on the heating plate 8.

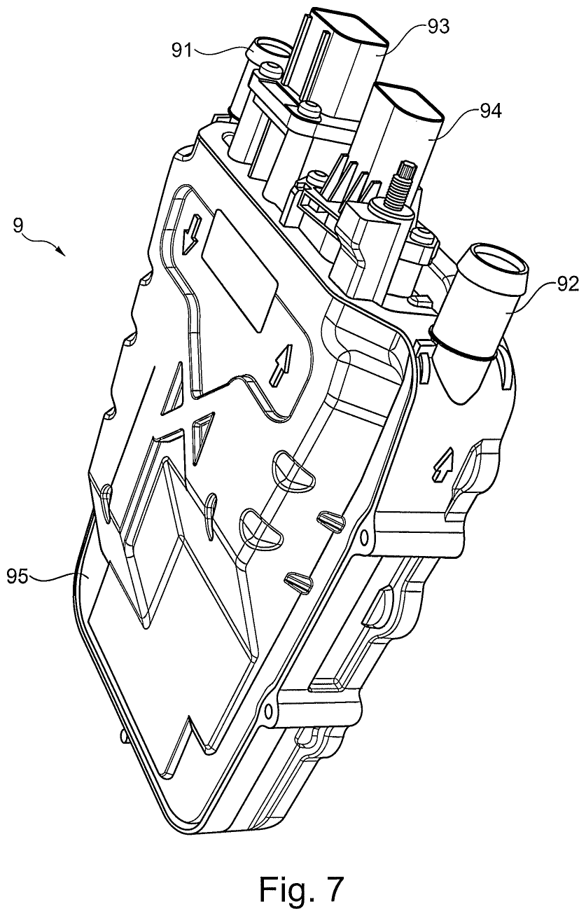

The printed circuit board 4 and the heating plate 8 as well as the connectors 1 electrically connecting them are part of a heating device 9 shown in FIG. 7. The heating device 9 is flow heater 9 that has an operating voltage in the range of 400 V to 800 V. Thus the connectors 1 described above are used for a high voltage connection inside an electrical device. The heating device 9 has an inlet 91 and an outlet 92 for fluid to be heated as well as electrical connector sockets 93, 94. A flow channel for fluid to be heated extends in a housing 95 from the inlet 91 to the outlet 92 along the heating plate 8.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 connector
2 plastic body
3 metallic strip
4 printed circuit board
5 openings
6 through holes
8 heating plate
9 flow heater
21 circular bead
22 protrusion
31 press-fit contacts
32 solder pads
91 inlet
92 outlet
93 electrical connector socket
94 electrical connector socket
95 housing

1. A connector for a high voltage connection inside an electrical device, said connector comprising:
a plastic body; and
a plurality of metallic strips that each have two ends that protrude from the plastic body;
wherein the metallic strips form press-fit contacts at least at one of their ends and each metallic strip has a through hole that matches with a corresponding opening of the plastic body; and
the plastic body comprises ring shaped beads that each surround one of the openings.

2. The connector according to claim 1, wherein the metallic strips form solder pads at one of their ends.

3. The connector according to claim 2, wherein the ends that are solder pads are bent at a right angle with respect to the press-fit contacts.

4. The connector according to claim 1, wherein the plastic body comprises protrusions configured for insertion into holes of a printed circuit board.

5. The connector according to claim 4, wherein the protrusions are arranged between the press-fit contacts of neighboring metallic strips.

6. The connector according to claim 1, wherein each metallic strip forms at least two press-fit contacts at one end.

7. The connector according to claim 1, wherein the press-fit contacts each have a bulging middle section.

8. The connector according to claim 1, wherein the bulging middle section has a through hole.

9. The connector according to claim 1, wherein the press-fit contacts are coated with nickel and/or tin.

10. The connector according to claim 1, wherein the through holes of the metallic strips and the matching openings of the plastic body are through holes of the connector.

11. A heating device, comprising a heating plate, a printed circuit board, and a connector according to claim 1 electrically connecting the heating plate to the printed circuit board.
